(19) United States
(12) Patent Application Publication
(10) Pub. No.: US 2026/0208874 A1
(43) Pub. Date: Jul. 23, 2026

(54) ELECTRICAL SUPPLY CIRCUIT FOR A TURBINE ENGINE, TURBINE ENGINE AND AIRCRAFT COMPRISING SUCH A TURBINE ENGINE

(71) Applicant: SAFRAN HELICOPTER ENGINES, BORDES (FR)

(72) Inventors: Thomas KLONOWSKI, Moissy-CRAMAYEL (FR); Fabien LESCHER, Moissy-CRAMAYEL (FR); Sébastien DETRY, Moissy-CRAMAYEL (FR); Olivier Audrey David LAFARGUE, Moissy-CRAMAYEL (FR); Yohan Frédéric André ARNAUD, Moissy-CRAMAYEL (FR)

(21) Appl. No.: 19/140,624

(22) PCT Filed: Dec. 19, 2023
(86) PCT No.: PCT/FR2023/052054

§ 371 Date: Jun. 18, 2025

(30) Foreign Application Priority Data
Dec. 20, 2022 (FR) FR2214011

(51) Int. Cl. B64D 31/18; B64D 27/10; B64D 27/33; B64D 27/35; B64D 35/025; B64D 45/00; H02J 4/00

(52) U.S. Cl. CPC B64D 31/18; B64D 27/10; B64D 27/33; B64D 27/35; B64D 35/025; B64D 45/00; H02J 4/00

(57) ABSTRACT

Electrical supply circuit of a turbine engine comprising a high-voltage DC circuit powered by a high-voltage DC source, connected to at least one DC/AC converter, the at least one DC/AC converter being respectively connected to at least one rotary electrical machine, the at least one rotary electrical machine being respectively coupled to at least one propeller of the turbine engine so as to rotate the at least one propeller or to generate electricity by the rotation of the at least one propeller, the circuit comprising at least one voltage step-up stage connected between the high-voltage source and the at least one DC/AC converter, the at least one voltage step-up stage being capable of raising the voltage provided to the at least one rotary electrical machine when the rotary electrical machine rotates the at least one propeller.

### TECHNICAL FIELD

The present invention relates to the field of turbine engines and more specifically relates to an electrical supply circuit for a turbine engine integrating a rotary electrical machine as well as a turbine engine comprising such a circuit and an aircraft comprising such a turbine engine.

### PRIOR ART

Climate change is a major concern for many legislative and regulatory bodies around the world. Indeed, various restrictions on carbon emissions have been, are or will be adopted by various states. In particular, an ambitious standard applies not only to new types of aircraft but also to those currently in circulation requiring the implementation of technological solutions in order to make them compliant with the regulations in force. Civil aviation has been taking action for several years now to make a contribution to the fight against climate change.

Technological research efforts have already made it possible to significantly improve the environmental performance of aircraft. The Applicant considers the factors impacting in all design and development phases to obtain aeronautical components and products that are less energy-consuming, more environmentally friendly and whose integration and use in civil aviation have moderate environmental impacts with the aim of improving the energy efficiency of aircraft.

Consequently, the Applicant is continuously working to reduce its negative climate impact through the use of methods and the operation of virtuous development and manufacturing methods and minimizing greenhouse gas emissions to as little as possible to reduce the environmental footprint of its activity.

This sustained research and development work covers both the new generations of aircraft engines, the reduction of the weight of aircraft, in particular through the materials used and lighter on-board equipment, the development of the use of electrical technologies to ensure propulsion, and, indispensable complements to technological progress, aviation biofuels.

Document FR 3 116 303, filed on behalf of Safran Helicopter Engines, describes the possibility of equipping an aircraft with a turbine engine, such as a turboprop, integrating both a gas turbine in a thermal part and a rotary electrical machine in an electrical part. The thermal part and the electrical part make hybrid operation of the turbine engine possible. The rotary electrical machine makes it possible to offer both an electricity generation function, in generator mode, to supply the aircraft with electricity, and a propulsion function in the context of ground movements of the aircraft, in particular taxiing type movements.

However, there are situations where transient extra power is required, in relation to the power limits that the turbine engine can provide. Indeed, the thermal part of the turbine engine may be limited in engine speed or acceleration and the electrical part also has power limits.

The FADEC can, for example, detect the attainment of intrinsic limitations of the gas turbine, that is to say a limitation of the power delivered, in particular in high altitude conditions with high temperatures. In such a case, a need for extra power is identified.

### DISCLOSURE OF THE INVENTION

The aim of the invention is to solve the aforementioned problems of the prior art by providing an electrical supply circuit of a turbine engine comprising a high-voltage DC circuit powered by a high-voltage DC source, connected to at least one DC/AC converter of the electrical supply circuit, the at least one DC/AC converter being respectively connected to at least one rotary electrical machine, the at least one rotary electrical machine being respectively coupled to at least one propeller of the turbine engine so as to rotate the at least one propeller or to generate electricity by the rotation of the at least one propeller,
the electrical supply circuit comprising at least one voltage step-up stage connected between the high-voltage source and the at least one DC/AC converter, the at least one voltage step-up stage being capable of raising the voltage provided to the at least one rotary electrical machine when said rotary electrical machine rotates the at least one propeller.

Thanks to the invention, it is possible to obtain extra power in a transient or stabilized manner, in relation to the power limits that the turbine engine can provide when necessary.

This extra power, or “electric boost”, may exist across the entire rotational speed range of the turboprop. It does not create any wear compared to a situation where extra power would be provided by an increase in the speed of the gas turbine, which would create wear on the latter.

The turbine engine electrical circuit according to the invention is particularly adapted to provide a transient or stabilized electric boost in the event of detection of a power requirement, within a turbine engine with an electric hybrid architecture, in particular for an electric taxiing functionality of the aircraft.

According to alternative preferred features, the at least one voltage step-up stage comprises a boost-type converter, or an interlaced boost-type converter, or a DAB-type converter, or a Quasi Z-source-type converter.

According to a preferred feature, the electrical supply circuit of a turbine engine further comprises a low-voltage DC circuit connected to the high-voltage DC circuit by means of a converter of the electrical supply circuit.

According to a preferred feature, the electrical supply circuit of a turbine engine further comprises a contactor connected in parallel to the voltage step-up stage. The invention also relates to a turbine engine comprising an electrical supply circuit as described previously.

The invention also relates to an aircraft comprising a turbine engine as described previously.

The invention also relates to a method for controlling at least one voltage step-up stage in an electrical supply circuit of a turbine engine as described previously, characterized in that it comprises steps of:
detecting a power requirement greater than the power that the turbine engine is able to deliver,
controlling the activation of the voltage step-up stage so that it delivers a high voltage to the rotary electrical machine for a transient period, when a power requirement greater than the power that the turbine engine is able to deliver is detected, and
controlling the end of the activation of the voltage step-up stage at the end of the transition period.

The turbine engine, the aircraft and the method have advantages similar to those described previously.

In a particular embodiment, the steps of the method according to the invention are implemented by computer program instructions.

Consequently, the invention also relates to a computer program on an information medium, this program being likely to be implemented in a computer, this program comprising instructions adapted to the implementation of the steps of a method as described above.

The invention also relates to a computer-readable information medium, and comprising computer program instructions adapted to implementing the steps of a method as described above.

### BRIEF DESCRIPTION OF THE DRAWINGS

Further features and advantages will become apparent upon reading the following description of a preferred embodiment, given by way of non-limiting example, described with reference to the figures wherein:

FIG. 1 illustrates a turbine engine, here a turboprop, according to one embodiment of the invention.

FIG. 2 illustrates the electrical architecture of the turbine engine, according to one embodiment of the invention.

FIG. 3 illustrates a part of a high-voltage DC sub-circuit of the electrical circuit of the turbine engine, according to one embodiment of the invention.

FIG. 4 illustrates a first variant of a voltage step-up stage included in the high-voltage DC sub-circuit of the electrical circuit of the turbine engine, according to one embodiment of the invention.

FIG. 5 illustrates a second variant of a voltage step-up stage included in the high-voltage DC sub-circuit of the electrical circuit of the turbine engine, according to one embodiment of the invention.

FIG. 6 illustrates a third variant of a voltage step-up stage included in the high-voltage DC sub-circuit of the electrical circuit of the turbine engine, according to one embodiment of the invention.

FIG. 7 illustrates a fourth variant of a voltage step-up stage included in the high-voltage DC sub-circuit of the electrical circuit of the turbine engine, according to one embodiment of the invention.

FIG. 8 illustrates a method for controlling the voltage step-up stage, according to one embodiment of the invention.

Identical, similar or equivalent parts of the various figures bear the same numerical references so as to facilitate the transition from one figure to another.

The various parts shown in the figures are not necessarily shown according to a uniform scale, to make the figures more readable.

The various possibilities (variants and embodiments) must be understood as not being exclusive of each other and can be combined with each other.

### DETAILED DISCLOSURE OF PARTICULAR EMBODIMENTS

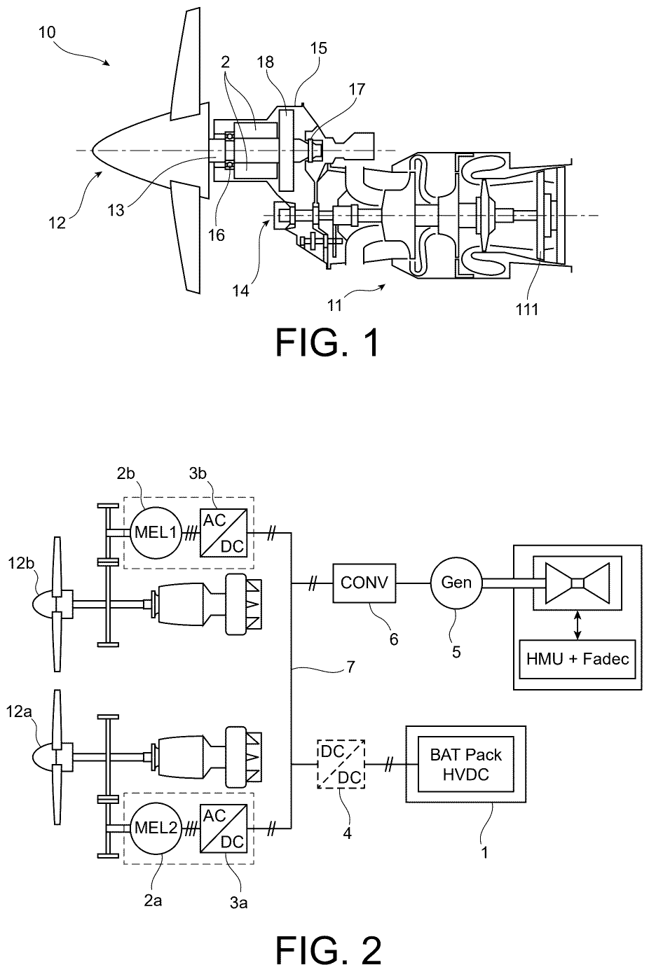

According to a preferred embodiment shown in FIG. 1, a turbine engine, here a turboprop 10, comprises a rotary electrical machine 2 capable of providing a generator function and a propulsion function. The propulsion function can be provided when the gas turbine is operating or stopped.

When the gas turbine is operating, the electrical machine is able to provide extra power. When the gas turbine is stopped, the electrical machine is able to provide the power required for a taxiing type movement.

Alternatively, the architecture can be fully electric instead of a thermal/electric hybrid.

The turbine engine 10 is a free turbine turboprop. The turboprop 10 comprises a gas turbine 11, a propeller 12, a propeller carrier shaft 13, extending towards the gas turbine 11 and being coupled, as described hereinafter, to a free turbine 111 by means of a transmission.

Thus, the gas turbine 11 comprises a high-pressure turbine, not referenced, rotating a turbine shaft 14 and a compressor, not referenced, and the free turbine 111 which drives a secondary shaft, not referenced, of the gas turbine, concentric to the turbine shaft 14.

The free turbine 111 is rotatably mounted about the turbine shaft 14 of the high-pressure turbine. The propeller carrier shaft 13 is surrounded by a protective housing 15. It is supported in the housing 15 by bearings 16 and 17. One of the bearings 16 is close to the propeller 12, and the other of the bearings 17 is adjacent to a gear wheel 18 for driving the propeller shaft 13, which meshes with the transmission mentioned above. In this example of the invention, the rotary electrical machine 19 is disposed concentrically about the propeller shaft 13, between the first bearing 16 and the gear wheel 18, by being surrounded by the housing 15.

Thus, in the present embodiment, the turbine engine is a “conventional” turboprop. Alternatively, the turbine engine may be a tilting rotor turbine engine, more known as a proprotor, which is intended to equip a vertical take-off aircraft known as a tiltrotor. The turbine engine may thus be both a turboprop or a turbine engine. The person skilled in the art is of course able to generalize the present information described for a “conventional” turboprop to these other types of turbine engines.

It should be noted that, as the gas turbine 11 is of the free turbine type, it offers two means for driving the elements of the turboprop, the high-pressure turbine and the turbine shaft 14 thereof, and the free turbine 111 and the secondary shaft thereof.

It should also be noted that, if the rotary electrical machine 2 is a simple rotary electrical machine capable of providing a generating function and an electric propulsion function, the rotary electrical machine 2 may have additional functions, such as those of powering a circuit for de-icing the blades of the propeller.

The rotary electrical machine 2 is preferably a brushless rotary electrical machine, this to limit the risks of wear and maintenance of the turboprop 10, and may thus be both a synchronous rotary electrical machine with permanent magnet and a synchronous rotary electrical machine with variable reluctance, or an asynchronous rotary electrical machine.

The propeller 12 is a single-acting variable pitch propeller. The propeller is driven by the gas turbine 11 and/or by the rotary electrical machine 2, as described in FR 3 116 303. The gas turbine 11 and the rotary electrical machine 2 are able to drive an engine oil pump 21 that makes it possible to circulate oil that in particular provides hydraulic pressure to a propeller control unit. The propeller control unit comprises an additional oil pump that is designed to raise the oil pressure provided by the engine oil pump to make it possible to hydraulically control the pitch of the propeller.

Thus, in the absence of oil pressure when the gas turbine is switched off and the rotary electrical machine is stopped, the propeller is in feathered position. When oil pressure is generated by the gas turbine and/or the rotary electrical machine, the pitch of the propeller decreases, which generates traction.

Interest is now paid to the electrical part of the turbine engine in particular. FIG. 2 schematically illustrates the electrical architecture of the turbine engine, according to one embodiment of the invention.

It should be noted that the invention may be implemented on a plurality of turboprops, for example two as shown in FIG. 2.

Thus, two propellers 12a and 12b are respectively capable of being rotated by two gas turbines and two rotary electrical machines 2a and 2b.

The electrical circuit of the turbine engine comprises a first High Voltage Direct Current (HVDC) sub-circuit.

The HVDC sub-circuit comprises an HVDC battery 1 preferably of the power type, constituting a voltage source able to generate a power for example between a few tens and a few hundreds of kilowatts, under a voltage for example of about several hundred volts, for a few seconds or several minutes.

The HVDC battery 1 is connected to a DC converter 4. The input voltage of the converter 4 is determined by the state of charge of the battery and the output voltage thereof is an adjustable direct voltage. The converter 4 is optional and can be of the serial buck type to lower the voltage, or of the parallel boost type to raise the voltage, or of the buck-boost type to lower or raise the voltage.

The DC converter 4 is connected to an HVDC bus 7, which in turn is connected to DC/AC converters 3a and 3b. Each of the DC/AC converters 3a and 3b is respectively connected to the electrical machine 2a and 2b. To ensure an electric propulsion of the aircraft, a direct electric current is provided via the HVDC bus 7 to the converters 3a and 3b which operate as inverters to convert the DC into alternating electric current and provide it to the electrical machines 2a and 2b so as to rotate the propellers 12a and 12b. Conversely, the converters 3a and 3b operate as rectifiers to convert an alternating electric current provided by the electrical machines 2a and 2b operating as generators into direct electric current provided to the battery 1 via the HVDC bus 7.

The structure of the converters 3a and 3b is detailed below.

The electrical circuit of the turbine engine preferably comprises a second low-voltage DC sub-circuit, typically 28 V. The low-voltage DC sub-circuit comprises a DC generator 5 and a battery capable of supplying electricity to the various equipment of the aircraft.

The first high-voltage DC sub-circuit and the second low-voltage DC sub-circuit are connected by means of a converter 6, for example as described in FR 3 116 303.

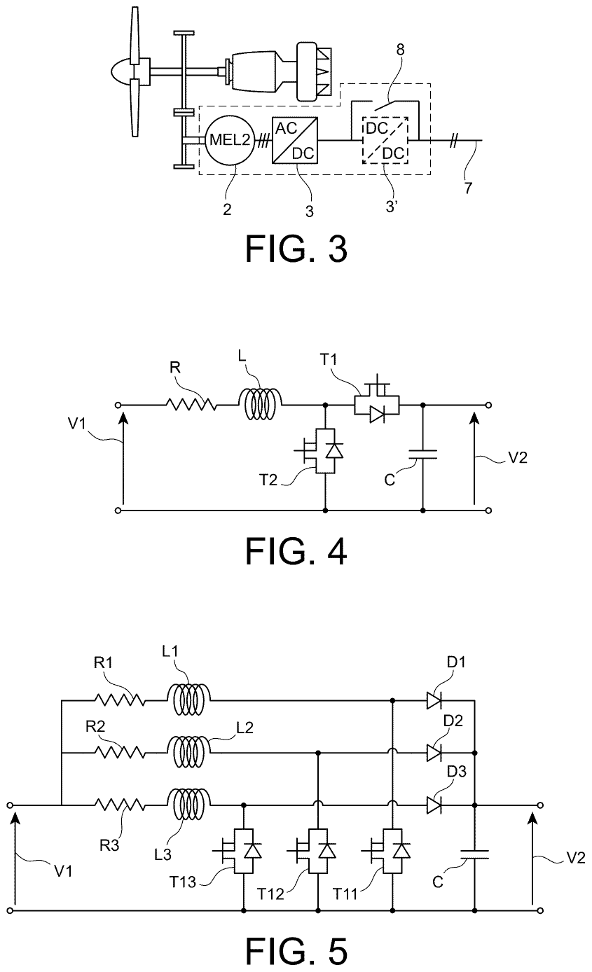

FIG. 3 schematically illustrates a part of the high-voltage DC sub-circuit of the electrical circuit of the turbine engine previously described and more particularly details the converter 3.

Thus, the HVDC bus 7, the converter 3 and the rotary electrical machine 2 are found, it being understood that the rotary electrical machine 2 and the converter 3 correspond respectively to each of the rotary electrical machines 2a and 2b and to each of the converters 3a and 3b of FIG. 2.

The converter 3 comprises a voltage step-up stage 3′, preferably integrated into the converter 3. Alternatively, the voltage step-up stage 3′ may be a separate component of the converter 3. The voltage step-up stage 3′ is of voltage step-up DC type.

A contactor 8 is preferably connected in parallel to the voltage step-up stage 3′.

The voltage step-up stage 3′ is able to raise the voltage provided from the HVDC bus 7 to the rotary electrical machine 2 transiently in order to overvoltage the electrical machine so that it generates additional transient power.

The contactor 8 is used to short-circuit the voltage step-up stage 3′ when the contactor 8 is closed.

The FADEC can, for example, detect the attainment of intrinsic limitations of the gas turbine, that is to say a limitation of the power delivered, in particular in high altitude conditions with high temperatures. In such a case, a need for extra power is identified.

The voltage step-up stage 3′ then makes it possible to provide a higher voltage to the rotary electrical machine 2. An electric boost is then generated and applied to the shaft of the propeller.

This electric boost can either increase the maximum power received by the propeller over a stabilized phase, in case of operation on a static limitation of the combustion engine, that is to say a limitation on a stop N1 or T4 corresponding to the maximum engine speed, or temporarily increase the instantaneous power received by the propeller in case of operation of the combustion engine on the acceleration limit thereof.

When no need for electric boost is identified, the voltage step-up stage 3′ is made inactive by closing the contactor 8, which prevents any energy dissipation.

According to one variant, the structure of the voltage step-up stage 3′ may be of the “boost” type as shown in FIG. 4.

In the embodiment of FIG. 4, the voltage step-up stage 3′ comprises an input at the terminals of which there is a direct voltage V1. From a first terminal of the input, the voltage step-up stage 3′ comprises a resistor R in series with an inductance L making it possible to store energy.

The inductance L is connected to a first transistor T1 also connected to a second input terminal of the voltage step-up stage 3′.

The inductance L is also connected to a second transistor T2 connected to a first output terminal of the voltage step-up stage 3′ and to a capacitor C. The capacitor C is also connected to a second output terminal of the voltage step-up stage 3′, the second output terminal of the voltage step-up stage 3′ being connected to the second input terminal of the voltage step-up stage 3′.

The first transistor T1 has a switch function to make it possible for energy to accumulate in the inductance L when it is closed and to make it possible to transfer this energy to the capacitor C when it is open. The output voltage V2 at the output terminals of the voltage step-up stage 3′ is thus higher than the input voltage V1.

This variant is particularly suitable when the amplification ratio between the input voltage V1 and the output voltage V2 does not exceed 3.

According to another variant, the structure of the voltage step-up stage 3′ may be of the “interlaced boost” type as shown in FIG. 5.

In this case, the first input terminal is connected to a plurality of parallel branches, three parallel branches in the example shown, each comprising a resistor R1, R2 and R3 in series with an inductance L1, L2 and L3. Each of the inductances L is connected to a respective transistor T11, T12 and T13, which in turn is connected to a second input terminal of the voltage step-up stage 3′. Each of the inductances L is also connected to a respective diode D1, D2 and D3 connected to a first output terminal of the voltage step-up stage 3′ and to a capacitor C. The capacitor C is also connected to a second output terminal of the voltage step-up stage 3′, the second output terminal of the voltage step-up stage 3′ being connected to the second input terminal of the voltage step-up stage 3′.

This variant makes it possible to maintain an optimum operation even in the event of a transistor failure and limits the current ripples at the input of converter 3.

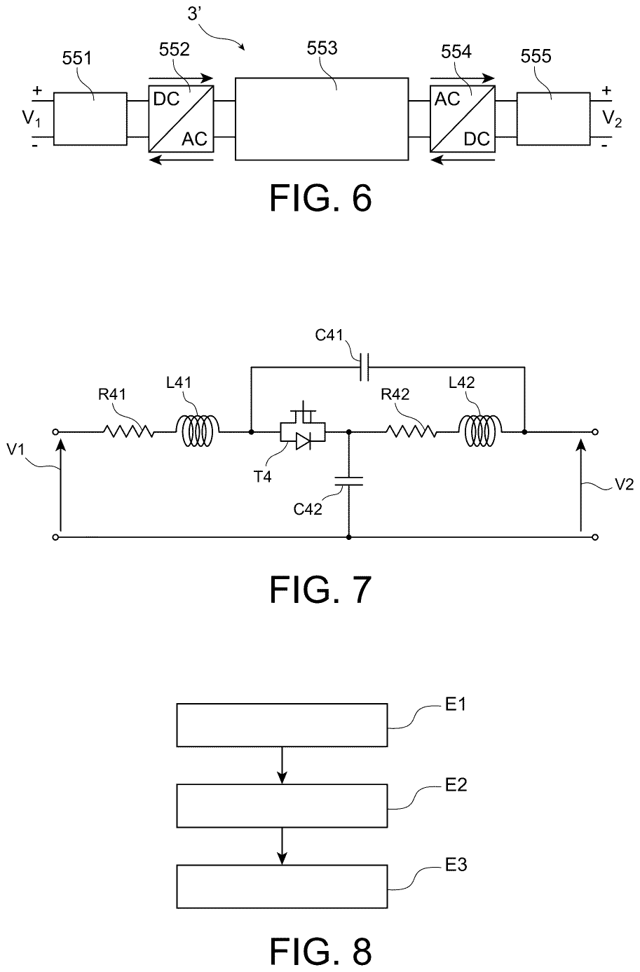

According to another variant, the structure of the voltage step-up stage 3′ may be of the Dual Active Bridge (DAB) type as shown in FIG. 6. This variant is suitable for a voltage amplification that may go up to 3. This structure is also interesting because it makes galvanic isolation possible between the HVDC bus 7 and the converter 3. This structure also makes it possible to have a bidirectional current, that is to say that this type of converter may also be used for a propeller braking function. This functionality of returning energy to the grid is particularly interesting in the case where it is desired to brake the propellers quickly for reasons of avoiding obstacles such as a bird or power line, for example.

The voltage step-up stage 3′ comprises, starting from the HVDC bus 7 to the converter 3:
a first low-pass filtering stage 551, in particular adapted to filter at least partially the frequencies for example greater than or equal to 1 KHz,
a second reversible DC/AC converter stage 552 that is able to provide both an inverter function, for an energy transfer from the HVDC bus 7 to the converter 3, and a rectifier function, for an energy transfer from the converter 3 to the HVDC bus 7, the second stage being capable of providing a high frequency alternating voltage, for example greater than or equal to 1 KHz,
a transformer 553 configured to raise the alternating voltage provided by the second stage, the transformer preferably being a resonant transformer, that is to say that the resonance frequency of the primary-side circuit of the transformer 553 is preferably equal to the resonance frequency of the secondary-side circuit of the transformer 553, the second DC/AC converter stage 552 being then preferably configured to provide an alternating voltage at a frequency substantially equal to the resonance frequency of the circuits on the primary and secondary side of the transformer 553,
a third reversible AC/DC converter stage 554 that is able to provide both a rectifier function, for an energy transfer from the HVDC bus 7 to the converter 3, and an inverter function, for an energy transfer from the converter 3 to the HVDC bus 7, the third stage being capable of providing a high frequency alternating voltage, for example greater than or equal to 1 KHz. In the case where the transformer 553 is a resonant transformer, the third reversible AC/DC converter stage 554 is then preferably configured to provide an alternating voltage at a frequency substantially equal to the resonant frequency of the circuits on the primary and secondary side of the transformer 553,
a fourth low-pass filtering stage 555, in particular adapted to filter at least partially the frequencies greater than or equal to 1 KHz.

It should be noted that the first and fourth filtering stages 551, 555 are not necessarily necessary and that, in a simplified configuration, it is conceivable not to provide them or, advantageously, to only provide the first filtering stage 551 so as to protect the HVDC bus 7.

According to another variant, the structure of the voltage step-up stage 3′ may be of the Quasi Z-source type as shown in FIG. 7. This variant optimizes the weight of the converter. Indeed, the inductances of the circuit may be coupled, which limits the weight thereof and the footprint thereof and which also makes it possible to limit EMC rejection in differential mode at the input of the converter 3.

The voltage step-up stage 3′ comprises, starting from the HVDC bus 7 to the converter 3, two input terminals. From a first input terminal, the voltage step-up stage 3′ comprises a first resistor R41, a first inductance L41, a transistor T4, a second resistor R42 and a second inductance L42 in series. The second inductance L42 is connected to a first output terminal of the voltage step-up stage 3′.

A first capacitor C41 is connected in parallel to the transistor T, the second resistor R42 and the second inductance L42.

A second capacitor C42 is connected between a midpoint between the transistor T4 and the second resistor R42 and a second input terminal of the voltage step-up stage 3′. The second input terminal of the voltage step-up stage 3′ is connected directly to a second output terminal of the voltage step-up stage 3′.

FIG. 8 illustrates an embodiment of a method for controlling the voltage step-up stage 3′ and comprises steps E1 to E3.

The first step E1 is the detection that the power to be provided by the turbine engine to properly ensure the regulation objectives thereof is greater than the maximum power permitted by the intrinsic limitations of the turbine engine. The regulation objectives typically depend on the control of the propeller speed. The intrinsic limitations of the turbine engine correspond, for example, to engine limitations in engine speed or acceleration. For example, this detection is performed by the FADEC of the aircraft.

When this detection is performed, step E1 is followed by step E2 at which the information is provided to a supervisor which then controls the activation of the electric boost on the rotary electrical machine. The supervisor is for example a supervisor of the thermal part and the electrical part of the turbine engine.

The activation of the electric boost comprises opening the contactor 8 and supplying electricity to the voltage step-up stage 3′ via the HVDC bus 7.

As already mentioned, the electric boost conferred using the voltage step-up stage can either increase the maximum power received by the propeller over a stabilized phase, for example in case of operation on a static limitation of the combustion engine, or temporarily increase the instantaneous power received by the propeller, for example in case of operation of the combustion engine on the acceleration limit thereof.

Here, the electric boost is preferably transient. At the end of the transitional period, step E2 is followed by step E3 at which the supervisor controls the end of the electric boost by controlling the closing of the contactor 8 so as to short-circuit the voltage step-up stage.

What is claimed is:

1. An aircraft comprising a turbine engine comprising an electrical supply circuit of a turbine engine comprising a high-voltage DC circuit powered by a high-voltage DC source, connected to at least one DC/AC converter of the electrical supply circuit, the at least one DC/AC converter being respectively connected to at least one rotary electrical machine of the turbine engine, the at least one rotary electrical machine being respectively coupled to at least one propeller of the turbine engine so as to rotate the at least one propeller or to generate electricity by the rotation of the at least one propeller,
the electrical supply circuit comprising at least one voltage step-up stage connected between the high-voltage source and the at least one DC/AC converter the at least one voltage step-up stage being capable of raising the voltage provided to the at least one rotary electrical machine when said rotary electrical machine rotates the at least one propeller,
wherein the aircraft further comprises a full authority digital engine control (FADEC):
adapted to detect a power requirement greater than the power that the turbine engine is able to deliver,
adapted to control the activation of the voltage step-up stage so that it delivers a high voltage to the rotary electrical machine for a transient period, when a power requirement greater than the power that the turbine engine is able to deliver is detected, and
adapted to control the end of the activation of the voltage step-up stage at the end of the transition period.

2. The aircraft according to claim 1, wherein the at least one voltage step-up stage comprises a boost type converter.

3. The aircraft according to claim 1, wherein the at least one voltage step-up stage comprises an interlaced boost type converter.

4. The aircraft according to claim 1, wherein the at least one voltage step-up stage comprises a DAB type converter.

5. The aircraft according to claim 1, wherein the at least one voltage step-up stage comprises a Quasi Z-source type converter.

6. The aircraft according to claim 1, further comprising a low-voltage DC circuit connected to the high-voltage DC circuit by means of a converter of the electrical supply circuit.

7. The aircraft according to claim 1, further comprising a contactor connected in parallel to the voltage step-up stage.

8. A turbine engine comprising an electrical supply circuit of a turbine engine, adapted to equip an aircraft according to of claim 1.

9. An electrical supply circuit of a turbine engine adapted to equip an aircraft, according to claim 8.

10. A method for controlling at least one voltage step-up stage in an electrical supply circuit of a turbine engine of an aircraft according to claim 1, wherein it comprises steps of:
detecting a power requirement greater than the power that the turbine engine is able to deliver,
controlling the activation of the voltage step-up stage to deliver a high voltage to the rotary electrical machine for a transient period, when a power requirement greater than the power that the turbine engine is able to deliver is detected, and
controlling the end of the activation of the voltage step-up stage at the end of the transition period.
